(19) United States
(12) Patent Application Publication
(10) Pub. No.: US 2005/0283464 A1
(43) Pub. Date: Dec. 22, 2005

(54) Method and apparatus for selective internet advertisement

(76) Inventors: James F. Allsup, Belleville, IL (US); Scott Poston, Millstadt, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/865,158

(22) Filed: Jun. 10, 2004

(51) Int. Cl. G06F 17/60; G06F 7/00

(52) U.S. Cl. 707/3; 705/14

(57) ABSTRACT

A method and apparatus for displaying advertisement information to a user searching for desired information within a data network such as the Internet. A search request is received from the user which includes at least one search key word associated with the desired information. A search is conducted in a first database of information, based upon the received search key word, to generate search results having a primary relevance to the search key word. A second search is conducted in a second database of advertisement information, based upon the received search key word, to identify advertisement data having a predetermined association with the search key word and which is mutually exclusive with the search results from the first database. The primary search results are provided to the user together with the identified advertisement data.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates to a method, apparatus, and computer program product for providing selected advertisements to a user over the Internet based upon predetermined relationships between the search terms entered by the user and the advertisements selected for display.

It is well known that the Internet provides computer users with access to a tremendous amount of information across a wide range of topics. Users seeking to access information on a particular topic typically utilize a web browser software application or computer program to access an Internet search engine such as Google™ or Yahoo!™ to facilitate identification of relevant web pages. These search engines accept key word entries from the user, and access vast databases of websites to identify those which most closely match the information sought by the user, based upon any of a variety of search and association techniques.

Results obtained by search engines are typically displayed to the user in the form of hyperlink listings in the user's web browser software application or computer program, and each may be accompanied by brief description of the identified search result. A portion of the displayed results is commonly dedicated to advertisements provided from the search engine to the user's web browser software application or computer program in connection with the search results. Typically, these advertisements are either targeted at a mass audience, and have no relationship to the search results provided to the user, or are directly related to the search results provided to the user. For example, a user searching for information related to local automobile repair shops may receive advertisements for dating services or mortgage refinancing targeted at a mass audience, as well as directly related advertisements for automotive repair shops located in the user's geographic vicinity.

When selecting which advertisements to display to a user together with the user's search results, little or no selection process is employed to choose advertisements targeted at a mass audience. By their nature, these advertisements seek to attract the attention of as many users as possible, and are therefore preferably presented to users as often as possible, regardless of the nature of the user's search. In contrast, advertisements which are directly related to the search results provided by the user are typically selected by the search engine for display to the user utilizing the user's identified key words to search an advertisement database for relevant advertisements. The resulting advertisements are hence, directly related to the user's search, but are likely to be duplicative of the search results returned to the user by the search engine. For example, a user searching for information related to local automobile repair shops may receive a listing of a dozen repair shops in his geographical vicinity, and simultaneously, receive displayed advertisements for half of them. Since the user has already received information about the repair shops that have displayed advertisements, the impact and benefit to the user of the displayed advertisements is significantly reduced.

Accordingly, it would be advantageous to provide a method, an apparatus, and a computer program which operate in conjunction with an Internet search engine to provide a user with search results from the user's key word search as well as selective advertisements which are indirectly relevant to the user's search, and which are substantially non-duplicative or mutually exclusive of the search results returned to the user.

### BRIEF SUMMARY OF THE INVENTION

Briefly stated, a method of the present invention for providing an advertisement to a user over the Internet, comprises the initial step of detecting a search keyword that the user enters on a local computer through a web browser software application for submission to a search engine, followed by the step of accessing, on a remote computer, a database of search key words and associated advertisement information, to identify advertisement information associated with said detected search keyword, including an address at which associated advertisement data is stored. Next, search results are obtained from either the remote computer or a second remote computer. The search results are associated with the search keyword received from the search engine. The search results and associated advertisement information are communicated to the local computer. Finally, obtained search results are displayed together with the associated advertisement data in accordance with the advertisement information.

In an alternative embodiment of the present invention, a method and apparatus for displaying advertisement information to a user searching for desired information within a data network such as the Internet is provided. A search request is received from the user which includes at least one search key word associated with the desired information. A search is conducted in a first database of information, based upon the received search key word, to generate search results having a primary relevance to the search key word. A second search is conducted in either the first database or a second database of advertisement information, based upon the received search key word, to identify advertisement data having a predetermined association with the search key word, and which is mutually exclusive with the search results from the first database. The primary search results are provided to the user together with the identified advertisement data.

In an alternate embodiment of the present invention, a method of selectively providing an advertisement for social security disability services to a user over the Internet is provided. The method comprises the initial step of detecting one or more search keywords including medical or surgical terms, medical or surgical treatments, diseases, medical conditions, and medical symptoms that the user enters on a local computer through a web browser software application. Search results associated with the search keywords are obtained from a remote computer. A database of search key words pre-selected for association with advertisement information for social security disability services is accessed to identify advertisement information pre-selected for association with the detected search keywords and mutually exclusive with the search results. The identified advertisement information includes an Internet address at which identified advertisement data is stored. The search results and identified advertisement information are communicated to the local computer, where they are displayed together with the identified advertisement data in accordance with the identified advertisement information.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a block diagram of an overall system implanting a preferred embodiment of the present invention;

FIG. 2 is a block diagram of a method of the present invention for providing selective advertisement associated with a user entered search key word and search results;

FIG. 3 is a prior art screen capture of an Internet search engine interface with displayed search results and directly related advertisements shown in a window of a web browser software application; and

FIG. 4 is a screen capture of an Internet search engine interface with displayed search results and indirectly related advertisements of the present invention shown in a window of a web browser software application.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

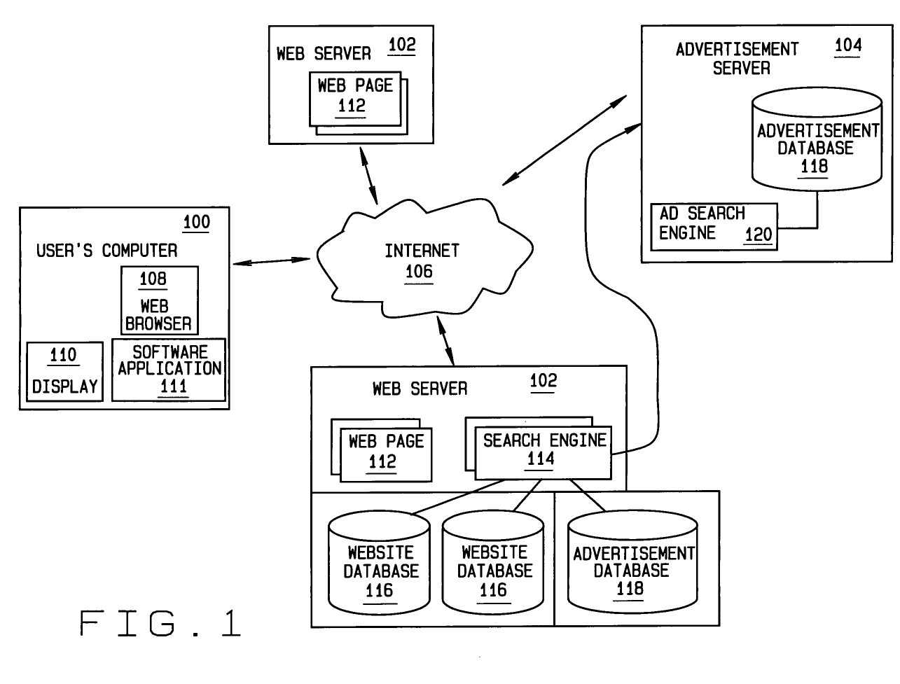

Referring to FIG. 1, there is shown a block diagram of an overall system implementing a preferred embodiment of the present invention. A user computer 100, one or more web servers 102, and an advertisement server 104 are connected through the Internet 106 or other data network adapted for the exchange of information.

The user computer 100 is configured with at least a web browser computer program 108 for communicating through the Internet 106, and a display 110 for providing a visual display of information to the user. Those of ordinary skill in the art will recognize that the user computer 100 may consist of any of a variety of commonly available hardware and software components, such as input and output devices, operating systems, and software applications. For example, the user computer 100 may be, but is not limited to, an IBM-PC compatible computer configured with a Microsoft Windows operating system, a UNIX operating system, or a Linux operating system. The user computer 100 further includes communication components and software applications 111 enabling the connection to the Internet 106 or other data network.

The web browser program 108 is a software application program utilized by a user to navigate web sites over the Internet. Commonly available web browser programs 108 include Internet Explorer™, available from Microsoft Corporation of Redmond, Wash., and Netscape Navigator™, available from Netscape Corporation of Mountain View, Calif.

Each web server 102 generally operates at least one web portal site including a plurality of web pages 112 that the user can access by entering a certain URL address into the web browser 108. Alternatively, the user can access various web pages 112 through the use of hyperlinks embedded into documents on the user computer 100, or by selecting a preset website from a list of websites accessible to the web browser 108. At least one web server 102 accessible to the user via the Internet 106 provides an Internet search engine 114 which enables a user to search for information and web pages 112 associated with one or more key words, terms, or phrases, provided by the user. Examples of commonly utilized Internet search engines 114 include Google™ and Yahoo!™. Each Internet search engine 114 may access one or more website databases 116 containing web site addresses indexed by key words, topics, or content. The website databases 116 may be stored local to the web server 102, as shown in FIG. 1, or may be accessed by the Internet search engine through the Internet 106.

In the preferred embodiment, the Internet search engine 114 is further configured to access an advertisement server 104, either directly, or through the Internet 106. The Internet search engine 114 provides the advertisement server 104 with the search key words or phrases on which a search is being conducted. The advertisement server 104 is configured with a lookup advertisement database 118 in which are stored one or more advertisements, advertisement URL addresses, and associated key word indexes. The advertisement server 104 either renders the lookup advertisement database 118 accessible to the search engine 114 to extract advertisements associated with the provided search key words, or utilizes a local advertisement search engine 120 to access the lookup advertisement database 118 and return a set of advertisements associated with the provided search key words.

Those skilled in the art will recognize that in an alternative embodiment, the lookup advertisement database 118 may be stored local to the Internet search engine 114, and accessed directly thereby, or by an advertisement search engine 120 installed at the web server 102, in the same manner as a local website database 116, to extract advertisements associated with the provided search key words.

Entries in the website databases 116 and lookup advertisement database 118 are periodically updated by the appropriate servers 102, 104 by inserting, modifying, and/or deleting entries in the databases using a known database management software application.

In the preferred embodiment of the present invention, the lookup advertisement database 118 is populated with advertisement entries which each identify an advertisement, or an advertisement URL address, and at least one predetermined associated search term, such as a word or phrase. Each predetermined associated search term is selected to have an indirect relationship to the subject of the advertisement, such that web pages 112 corresponding to the subject of the advertisement are substantially unlikely to be identified by the Internet search engine 114 utilizing the same predetermined associated search term to identify entries in a website database 116. As used herein, the term “indirect relationship” is intended to identify a relationship between the advertisement, or the subject of the advertisement, and the predetermined associated search term which is not obvious to a user, and which is sufficiently abstract so as to preclude a commonly understood association of the advertisement, or the subject of the advertisement, with the predetermined associated search term outside of the advertisement database 118.

For example, in an embodiment of the present invention, an advertisement in the lookup advertisement database 118, or identified by a URL address stored in the lookup advertisement database 118, includes content identifying a company facilitating entitlement to social security disability insurance benefits for qualified individuals. A majority of individuals are unaware of the existence of social security disability insurance benefits, and accordingly, are unlikely to ever search the Internet for information related to such services. However, individuals may qualify for social security disability insurance benefits if they suffer from any of a wide range of medical conditions, or surgical conditions, diseases, or injuries.

Accordingly, advertisements in the lookup advertisement database 118, or identified by a URL address stored in the lookup advertisement database 118, include content identifying the company facilitating entitlement to social security disability insurance benefits for qualified individuals. The advertisements are associated with a set of predetermined or pre-selected associated search terms or phrases which have only an indirect relationship to social security disability insurance benefits, and may include specific medical condition (including a surgical condition), prognosis of one or more medical conditions, symptoms of one or more medical conditions, or statistical data associated with one or more surgical or medical conditions. Examples of such search terms or phrases may include, but are not limited to, fibromyalgia, osteoarthrosis, ischemic heart disease, rheumatoid arthritis, multiple sclerosis, carpel tunnel syndrome, sleeplessness, chronic fatigue syndrome. The primary, and possibly only, goal of a user entering such search terms or phrases into a web browser 108 or Internet search engine 114, is likely to be the location of web pages 112 detailing the specific surgical or medical condition for which the user is searching.

Advertisement information related to a company facilitating entitlement to social security disability insurance benefits for qualified individuals is only indirectly related to the goal and primary results of the user's search. Hence, the search results of the website databases 116 using the user-entered search terms are substantially unlikely to yield information related to obtaining social security disability insurance, and as such, the advertisements and associated advertisement content would remain unknown to the user absent the association of the of the advertisement database information with the set of predetermined or pre-selected search terms indirectly related to obtaining social security disability insurance.

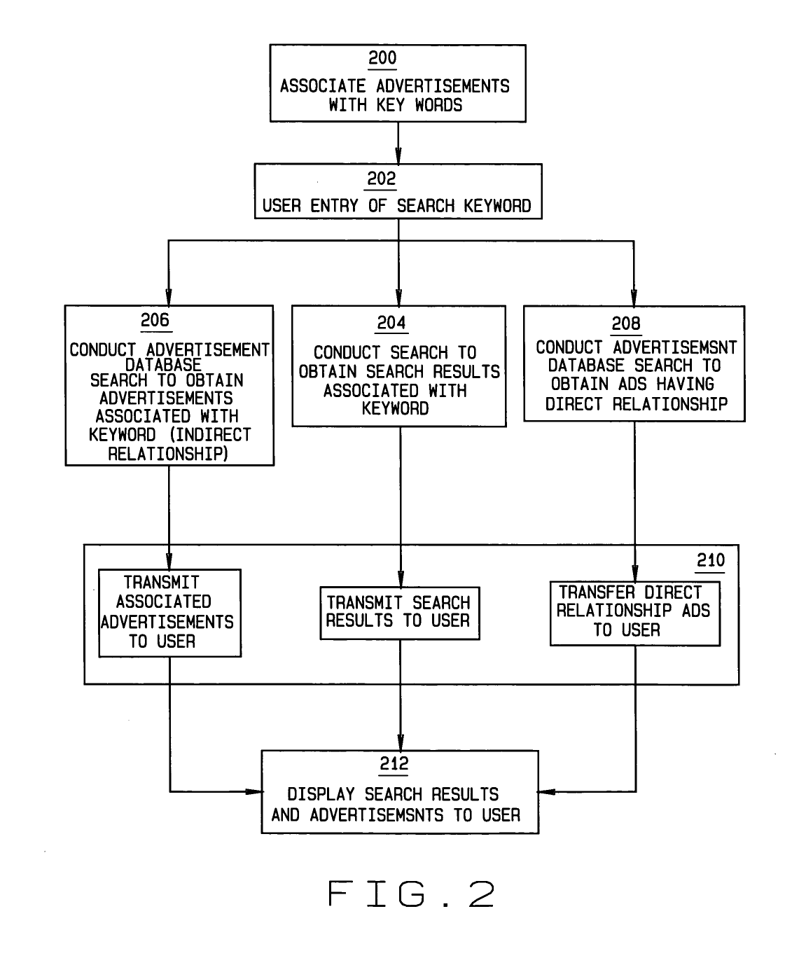

Referring to FIG. 2, there is shown a flow chart illustrating a method of providing an advertisement in accordance with an embodiment of the present invention.

First, in step 200, the lookup relationships in an advertisement database 118 are established. Advertisements and advertisement URL addresses stored in an advertisement database 118 are selectively associated with predetermined search key words or phrases. The predetermined search key words or phrases are associated at least with advertisements and advertisement URL addresses which conventional search logic would not identify as having an established direct relationship with the predetermined search key words or phrases, but which have more than a tenuous indirect relationship therewith.

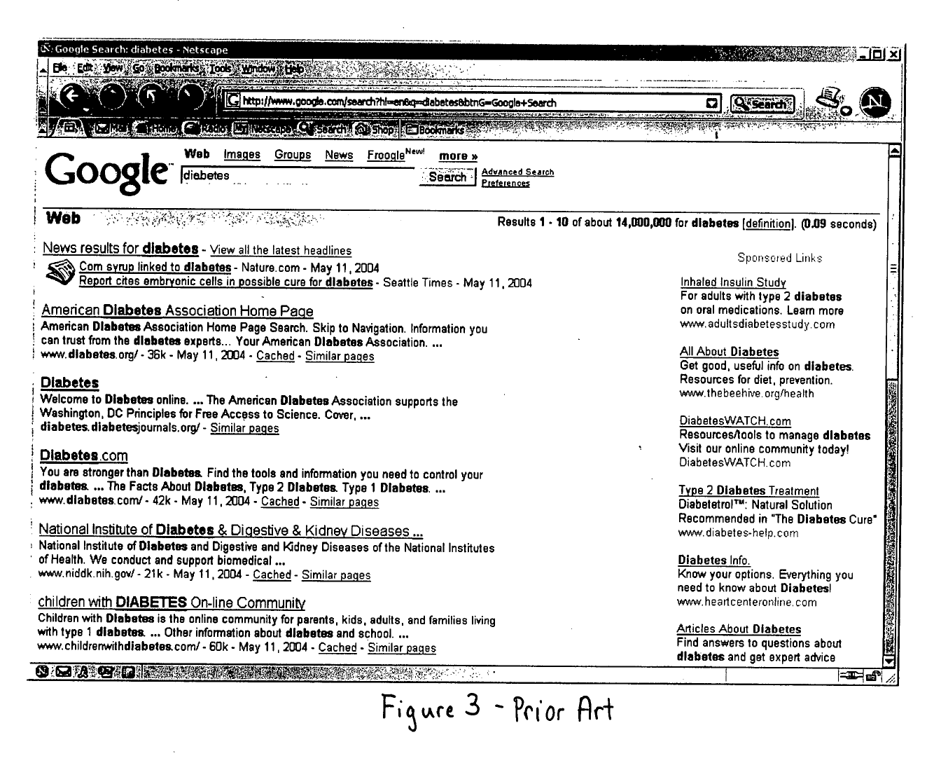

In step 202, one or more search key words or phrases are entered by a user into a web browser application 108 on the user computer 100 and communicated via the Internet 106 to a search engine 114 on a web server 102. FIG. 3 illustrates an exemplary screen shop of an interface to an Internet search engine 114 presented to a user in a display windows of a web browser application 108. The URL for the Internet search engine 114 is “http://www.google.com”, and the key word “diabetes” has been entered into the interface of the Internet search engine 114. The display includes a set of search results and a set of conventional “Sponsored Links” or advertisements each having a direct relationship to the key word entered by the user.

Returning to FIG. 2, the key words or phrases entered by the user into the web browser application 108 during step 202 are utilized by the search engine 114 in step 204 to conduct a search of one or more website databases 116 to identify websites or web pages 112 which are associated with the key words or phrases. In step 206, the same key words or phrases are similarly utilized by the search engine 114, or an advertisement search engine 120, to conduct a search of one or more advertisement databases 118 to identify advertisements or advertisement URL addresses indirectly related to the search key words or phrases, and which have been selectively associated with the search key words or phrases in step 200.

Optionally, in step 208, the same key words or phrases are similarly utilized by the search engine 114, or an advertisement search engine 120, to conduct a search of one or more advertisement databases 118 in a conventional manner to identify advertisements or advertisement URL addresses which are logically and directly related to the search key words or phrases.

In step 210, the various search results, associated advertisements, and advertisement URL address are transmitted via the Internet 106 to the user computer 100 for display in the web browser 108 in a conventional manner, as shown in step 212.

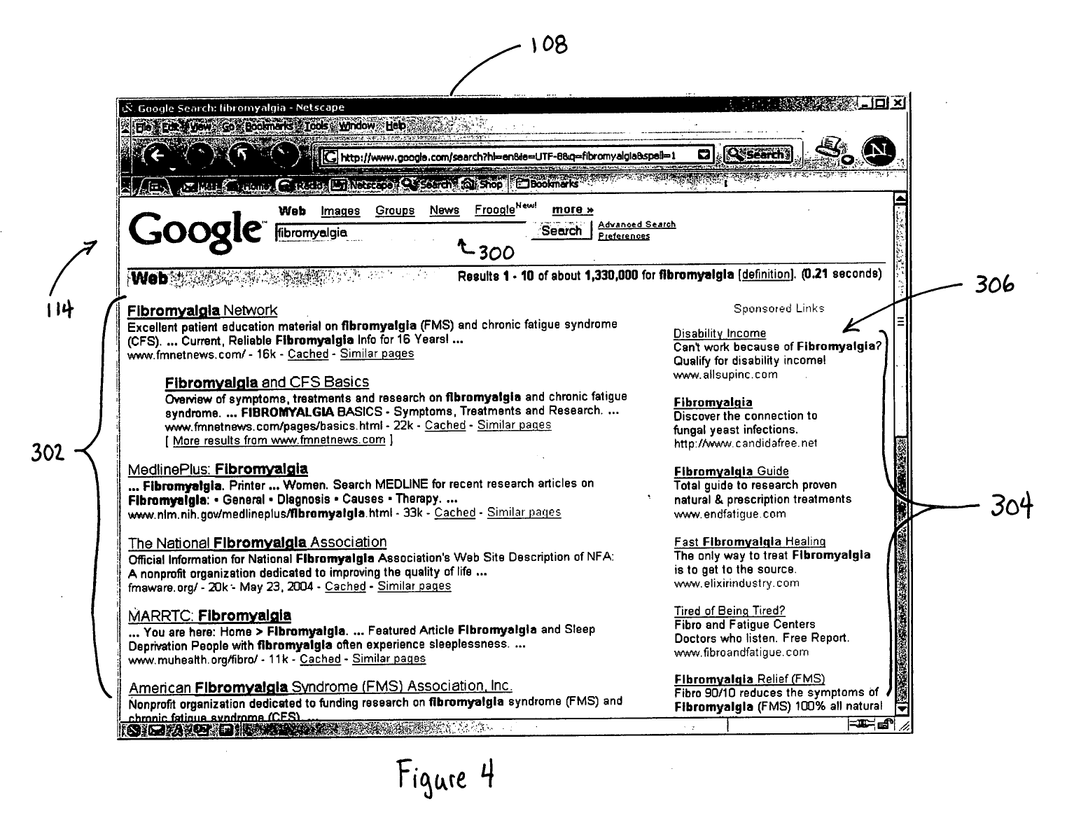

FIG. 4 illustrates an exemplary screen capture of an interface to an Internet search engine 114 presented to a user in a display window of a web browser application 108. The URL for the Internet search engine 114 is “http://www.google.com”, and the key word “fibromalgia” has been entered into the interface 300 of the Internet search engine 114. The display includes a set of search results 302 and a set of “Sponsored Links” or advertisements 304 including one or more advertisements 306 selected in accordance with the method of the present invention, and having a indirect relationship to the key word. The specific order in which the advertisements are displayed may be based on a weighted value assigned to the advertisement in the advertisement database 118, or may be based upon any conventional advertisement layout process, including assignment of a monetary value to available advertisement locations.

In an alternate embodiment of the present invention, a computer-readable medium is provided, having stored thereon program instructions executable by a user computer 100 to perform a method of selectively providing an advertisement for social security disability insurance representation services to a user over the Internet 106. The method comprises the initial step of detecting one or more search keywords including medical and/or surgical terms, medical and/or surgical treatments, diseases, medical (and/or surgical) conditions, and medical symptoms entered on a user computer 100 through a web browser software application 108. Search results associated with the search keywords are obtained from a remote computer such as a web server 102.

Additionally, an advertisement database 118 of search key words and associated advertisement information for social security disability insurance representation services is accessed to identify advertisement information which has been pre-selected or predetermined for association with the detected search keywords, and which is mutually exclusive with the search results, or which is indirectly related to the detected search keywords. The associated advertisement information may include an Internet address at which associated advertisement data is stored. The search results and associated advertisement information are communicated via the Internet 106 to the user computer 100, where they are displayed on a display 110 together with the associated advertisement data in accordance with the format and layout of the advertisement information.

The present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A method of providing an advertisement to a user over the Internet, comprising the steps of:
receiving a search keyword entered through a web browser software application;
accessing a database of search key words and associated advertisement information to identify advertisement information having a predetermined indirect relationship to said detected search keyword;
obtaining search results having a direct relationship to said received search keyword from at least one search engine;
communicating said search results and said identified advertisement information to said web browser software application;
displaying said obtained search results together with said identified advertisement information.

2. The method of claim 1 wherein said identified advertisement information includes an Internet address at which associated advertisement data is stored; and
wherein said displaying step includes displaying said advertisement data.

3. The method of claim 1 wherein said database of search key words and associated advertisement information includes at least one search key word associated with a medical condition.

4. The method of claim 1 wherein said database of search key words and associated advertisement information includes at least one search key word associated with a medical diagnosis.

5. The method of claim 1 wherein said database of search key words and associated advertisement information includes at least one search key word associated with a medical symptom.

6. The method of claim 1 wherein said database of search key words and associated advertisement information includes at least one search key word associated with a surgical condition.

7. The method of claim 1 wherein said database of search key words and associated advertisement information includes at least one search key word associated with a surgical diagnosis.

8. The method of claim 1 further including the steps of populating said database of search key words and associated advertisement information with at least one search key word and with at least one element of advertisement information having a predetermined indirect relationship to said at least one search keyword.

9. The method of claim 1 wherein said search results having a direct relationship to said search key word consist of at least one search results selected from a set including: diagnosis of a medical condition, treatment of a medical condition, prognosis of a medical condition, symptoms of a medical condition, surgical treatments, and statistical data associated with a medical condition; and
said identified advertisement information includes advertisement information related to obtaining social security disability insurance benefits.

10. The method of claim 1 wherein said identified advertisement information is mutually exclusive with said obtained search results.

11. The method of claim 10 wherein said identified advertisement information includes an advertisement associated with obtaining social security disability insurance benefits.

12. A method for displaying advertisement information to a user searching, within a data network, for desired information which is only indirectly related to the advertisement information, comprising the steps of:
receiving, from a user, a search request including at least one search key word associated with the desired information;
searching, based upon the receipt of said at least one search key word, a first database of information to generate a search result;
searching, based upon the receipt of said at least one search key word, a second database of advertisement information to identify advertisement data having a predetermined indirect association with said at least one search key word;
providing said search results to the user;
providing said identified advertisement data to the user;
wherein searching the first database identifies search results having a direct relevance to said at least one search key word; and wherein searching the second database identifies advertisement data which is mutually exclusive with said search results.

13. An apparatus which provides electronic advertisements to a client system coupled to the apparatus over a data network, the apparatus comprising:
a database which stores at least one electronic advertisement and at least one associated key word, said at least one electronic advertisement having a predetermined indirect relationship to said at least one associated key word;
an advertisement server configured to access said database for making said at least one electronic advertisement available to the client system;
a search engine operatively coupled to the advertisement server and to the client system, said search engine configured to receive at least one search term from the client system and to return a set of search results directly related with said at least one search term to the client system;
wherein said advertisement server is configured to receive said at least one search term, and to make available to the client system, electronic advertisements from said database associated with key words corresponding to said at least one search term.

14. The apparatus of claim 13 wherein said advertisement server is configured to present to the client system at least one electronic advertisements from said database which is mutually exclusive with said set of search results, and which is associated with a key word corresponding to said at least one search term.

15. The apparatus of claim 13 wherein said at least one electronic advertisement is for a social security disability insurance benefit representation service; and
wherein said at least one key word is selected from a set of key words including medical terms, surgical terms, medical treatments, surgical treatments, diseases, medical conditions, surgical conditions, and medical symptoms.

16. An apparatus which provides electronic advertisements to a client system coupled to the apparatus over a data network, the apparatus comprising:
a database which stores at least one electronic advertisement for a social security disability insurance benefit representation service and at least one associated key word, said at least one key word having a predetermined indirect relationship to said at least one electronic advertisement;
an advertisement server configured to access said database for presenting said at least one electronic advertisement to the client system;
a search engine operatively coupled to the advertisement server and to the client system, said search engine configured to receive at least one search term from the client system and to return a set of search results associated with said at least one search term to the client system;
wherein said advertisement server is configured to receive said at least one search term, and to return to the client system, electronic advertisements from said database associated with key words corresponding to said at least one search term.

17. An apparatus which provides electronic advertisements to a client system coupled to the apparatus over a data network, the apparatus comprising:
a database which stores at least one electronic advertisement and at least one associated key word, said at least one key word having a predetermined indirect relationship to said at least one electronic advertisement and wherein said at least one key word is selected from a set of key words including medical terms, surgical terms, medical treatments, surgical treatments, diseases, medical conditions, surgical conditions, and medical symptoms;
an advertisement server configured to access said database for presenting said at least one electronic advertisement to the client system;
a search engine operatively coupled to the advertisement server and to the client system, said search engine configured to receive at least one search term from the client system and to return a set of search results directly related with said at least one search term to the client system;
wherein said advertisement server is configured to receive said at least one search term, and to return to the client system, electronic advertisements from said database associated with key words corresponding to said at least one search term.

18. A method of providing an advertisement to a user over the Internet, comprising the steps of:
receiving a medically related search keyword entered through a web browser software application;
obtaining search results having a direct relationship to said received search keyword from at least one search engine, said search results selected from a set including at least: diagnosis of a medical condition, treatment of a medical condition, a surgical procedure, prognosis of a medical condition, symptoms of a medical condition, and statistical data associated with a medical condition or surgical condition;
obtaining at least one element of advertisement information which is mutually exclusive with said search results and related to obtaining social security disability insurance benefits;
communicating said search results and said advertisement information to said web browser software application; and
displaying said obtained search results together with said advertisement information.
